(19) United States
(12) Patent Application Publication
(10) Pub. No.: US 2002/0056603 A1
(43) Pub. Date: May 16, 2002

(54) Thrust plate assembly

(76) Inventor: Thomas Schwingenstein, Stuttgart (DE)

Correspondence Address: Thomas C. Pontani, Esq., Cohen, Pontani, Lieberman & Pavane, Suite 1210, 551 Fifth Avenue, New York, NY, 10176, US

(21) Appl. No.: 09/992,262

(22) Filed: Nov. 14, 2001

(30) Foreign Application Priority Data
Nov. 14, 2000 (DE) 100 56 277.9
Jun. 1, 2001 (DE) 101 26 781.9

(51) Int. Cl. F16D 13/50

(52) U.S. Cl. 192/70.18; 192/70.28; 192/200; 464/100

(57) ABSTRACT

A thrust plate assembly for a friction clutch, including a housing having an axis of rotation and a pressure plate arrangement which is held so as to be movable axially with respect to the housing by means of at least one leaf spring arrangement. The leaf spring arrangement has a first coupling area secured to a first mounting area of the pressure plate, a first longitudinal area adjoining the first coupling area, and a second longitudinal area adjoining the second coupling area. A leaf spring arrangement support is arranged in such a way that when the first coupling area and the second coupling area approach one another in a circumferential direction with respect to the axis of rotation, at least one of the first longitudinal area and second longitudinal area contacts the leaf spring arrangement support.

### BACKGROUND OF THE INVENTION

1. Field of the Invention

The present invention is directed to a thrust plate assembly for a friction clutch including a housing having an axis of rotation and a pressure plate which is movable axially with respect to the housing by means of at least one leaf spring arrangement. The leaf spring arrangement is secured in a first coupling area to a first mounting area of the pressure plate and is secured in a second coupling area to a second mounting area of the housing.

2. Description of the Related Art

A thrust plate assembly of the type mentioned above, which is known in principle from DE 198 48 582, is shown in a schematic axial view in FIG. 1. This thrust plate assembly 10 has a housing 12 in which a pressure plate 14 is secured so as to be movable in direction of the axis of rotation A and rotatable with respect to the housing 12 about the axis of rotation A only in a small range of angular rotation. For this purpose, a plurality of leaf spring arrangements 16 are provided. Mounting portions 18, 20 are provided at the housing 12 and at the pressure plate 14, wherein the leaf spring arrangements 16 which can have a leaf spring element, for example, are secured by their circumferential end areas to the respective portions 18, 20.

Particularly when using clutches with self-energizing or self-reinforcing engagement effect, the leaf spring arrangements 16 and the leaf spring elements thereof are generally constructed so as to be sharply bent. In other words, the coupling areas of the leaf spring arrangements 16 situated in circumferential direction are bent or inclined with respect to connection areas connecting the coupling areas. In normal torque transmission operation, i.e., in a pull state, the leaf spring elements 16 are generally acted upon in such a way that the two coupling areas and therefore also the mounting portions 18, 20 allocated to the latter at the housing arrangement 12 and pressure plate 14 tend to move apart in circumferential direction with respect the axis of rotation A. However, when the torque flow is reversed, which can occur, for example, when an engine braking effect is made use of, i.e., in a push state, there is, in principle, a tendency for the two coupling areas of the respective leaf spring arrangements 16 to approach one another in circumferential direction with respect to the axis of rotation A. However, this means that the leaf spring arrangements 16 are exposed to a comparatively high bending load in the push state, which occurs to a greater degree especially when, as was already mentioned, the coupling areas extend at a comparatively sharp angle with respect to a connection area.

### SUMMARY OF THE INVENTION

It is the object of the present invention to further develop a thrust plate assembly of the type mentioned above in such a way that the risk of bending of the leaf spring arrangements is prevented to a great extent even during transition to the push state.

According to the invention, this thrust plate assembly includes a leaf spring arrangement support, wherein when acted upon in such a way that the first coupling area and the second coupling area approach one another in circumferential direction with respect to the axis of rotation of the thrust plate assembly, the at least one leaf spring arrangement contacts the leaf spring arrangement support in a first longitudinal area adjoining the first coupling area and/or in a second longitudinal area adjoining the second coupling area.

The leaf spring arrangement support ensures that the leaf spring arrangement will be reinforced during the transition to the push state particularly in the area adjoining the coupling areas and, therefore, that it can not be deflected or bent in an undesirable manner when highly loaded.

In order to provide sufficient mobility for the pressure plate arrangement in axial direction, i.e., so that the springing movement of the leaf spring arrangements is not excessively limited in principle, it is suggested that the first longitudinal area and the second longitudinal area do not contact the leaf spring arrangement support when the leaf spring arrangement is essentially not loaded.

For example, it may be provided that the leaf spring arrangement support has a first support surface area at the pressure plate in the region of the first mounting area and/or a second support surface area at the housing in the area of the second mounting area.

In a particularly simple constructional variant, the first support surface area adjoins a surface region of the first mounting area which is contacted by the first coupling area of the leaf spring arrangement and/or the second support surface area adjoins a surface region of the second mounting area contacted by the second coupling area of the leaf spring arrangement.

In order to prevent line pressing from occurring during transition to the push state, i.e., in order to provide a more or less flat support, it is suggested that the surface region of the first mounting area and/or the surface region of the second mounting area is essentially flat and that the first support surface area or the second support surface area is curved away from the leaf spring arrangement.

The defined contacting of the leaf spring arrangement at the leaf spring arrangement support can be reinforced or guaranteed in particular in that the first coupling area and/or the second coupling area are/is inclined with respect to a plane extending essentially orthogonal to the rotational axis of the thrust plate assembly.

This can be achieved, for example, in that the surface region of the first mounting area and/or the surface region of the second mounting area are/is inclined relative to the plane.

As was already mentioned above, particularly in thrust plate assemblies in which a self-reinforcing engagement effect is to be achieved, it is advantageous when the first coupling area and/or the second coupling area, at least in an essentially unloaded state, are/is inclined with respect to a connection area of the leaf spring arrangement connecting the first coupling area and the second coupling area.

The at least one leaf spring arrangement can preferably have at least one leaf spring element.

The present invention is further directed to a friction clutch which comprises a thrust plate assembly according to the invention.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 shows a schematic axial view of a thrust plate assembly according to the invention; and

FIG. 2 shows a partial view of the thrust plate assembly according to the invention from the radial outside.

### DETAILED DESCRIPTION OF THE PRESENTLY PREFERRED EMBODIMENTS

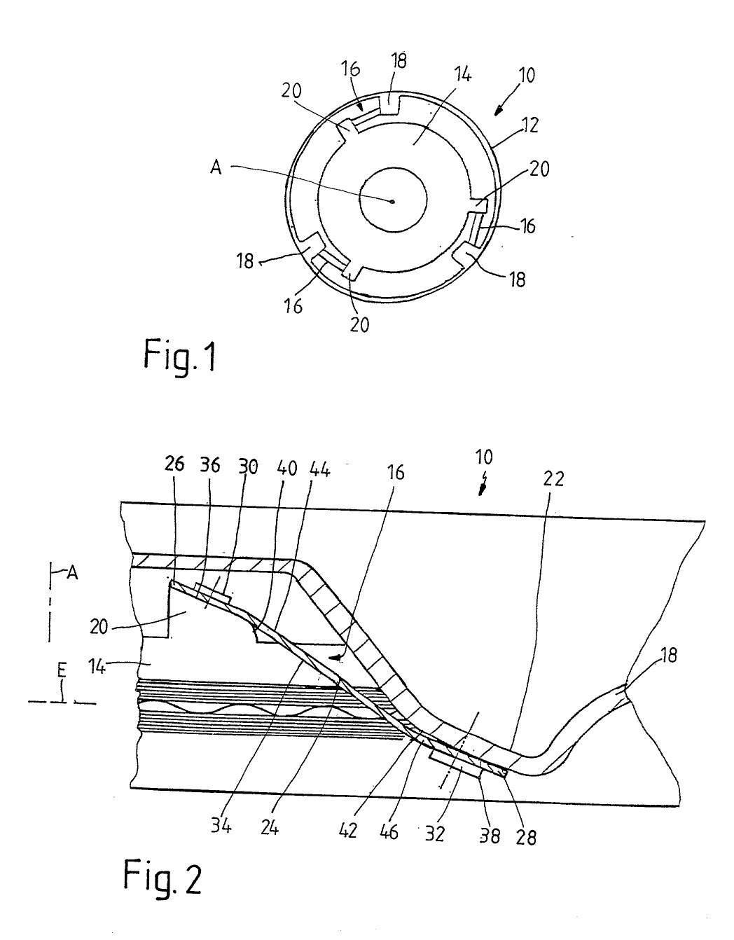

In the following, reference is had to FIG. 1 with respect to the basic construction of a thrust plate assembly according to the invention. In this thrust plate assembly 10, the housing arrangement 12 is generally formed by punching and shaping sheet metal material. In particular, the mounting portions 18 are provided by corresponding axial countersinks and radial flange portions 22.

In the present embodiment form, the leaf spring arrangement 16 or each leaf spring arrangement 16 comprises a leaf spring 24 which is fixedly arranged by rivet pins 30 and 32 at, respectively, the mounting portions 18 and 20 of the housing arrangement 12 and pressure plate 14 in the area of its coupling portions 26 and 28 located at the circumferential ends. A connection area 34 is arranged between the two coupling areas 26, 28. It will be seen in FIG. 2 that the coupling areas 26, 28 extend at an inclination or in a bent manner with respect to the connection area 34. For example, the leaf spring element 24 can be slightly S-shaped.

In the coupling areas 26, 28, the leaf spring element 24 is fixedly and permanently secured respectively to surface regions 36 and 38 of the pressure plate 14 and housing arrangement 12. These surface regions 36, 38 are preferably constructed so as to be substantially flat, that is, substantially without curvature, in order to produce a defined contact.

Further, it will be seen from FIG. 2 that support surface areas 40, 42 which extend in a curved manner and which are directed toward the other respective end of the leaf spring element 24 in circumferential direction adjoin the surface regions 36, 38. These curved support surface areas 40, 42 preferably adjoin the surface regions 36, 38 in a continuously distinguishable manner, i.e., without bends. It will further be seen in FIG. 2 that the curved support surface areas 40, 42 are curved away from the longitudinal areas 44, 46 of the leaf spring elements 24 situated in their area, these longitudinal areas 44, 46 adjoining the coupling areas 26, 28.

It will be seen further that the surface regions 36, 38 are positioned at an angle or inclination relative to a plane E extending essentially orthogonal to the axis of rotation A. As a result, the coupling areas 26, 28 are also held at an inclination relative to this plane E.

When a thrust plate assembly 10, as shown in FIG. 2, is compression loaded, i.e., when the pressure plate 14 is rotated or acted upon by the clutch disk in frictional cooperation with the pressure plate 14 in a direction with respect to the housing such that the coupling areas 26, 28 of the leaf spring element 24 tend to approach one another, the leaf spring element 24 will increasingly contact the support surface areas 40, 42 in the longitudinal areas 44, 46. The greater this action upon the pressure plate 14, the greater will be the surface region on which the leaf spring element 24 contact the support surface area 40, 42. Because of the curvature described above, there is a continuous transition to this supporting state.

This supporting of the leaf spring element 24 according to the invention in a compression loaded state has two essential consequences. For one, the pressure plate 14 is moved upward with reference to FIG. 2 by means of the deflecting movement which accordingly takes place, so that the pressing against the clutch disk is at least slightly decreased and alternating load reactions due to an at least slight slippage which becomes possible in a clutch outfitted with a thrust plate assembly 10 of this type can be contained. Further, the free unsupported length of the leaf spring element 24 in its connection area is decreased, as a result of which the risk of bending is considerably reduced. In particular, the leaf spring element 24 approximates a parallel orientation to the axis of rotation A to a greater degree in its connection area 34, so that even a comparatively strong compression loading of the leaf spring element 24 leads only to a lateral deformation, but not to deformation compression or bending.

A further advantage of the inventive inclination of the leaf spring element 24 in its coupling area 26, 28 consists in that a bending load caused by the bending of the leaf spring element 24 over support edges of one kind or another is also prevented to a great extent in the pull state, i.e., in a load state in which the two coupling areas 26, 28 tend to move away from one another. Instead, the slightly curved leaf spring element 24 is elongated, wherein the arrangement is preferably effected in such a way that the leaf spring element 24 adopts a virtually linear configuration in the maximum traction loaded state of the leaf spring element 24, so that edge pressing or line pressing at the heads of the fastening rivets 30, 32 due to bending of the coupling areas 26, 28 in the opposite direction with respect to the connection area 24 essentially does not occur or, if so, with only very slightly.

The present invention provides a thrust plate assembly which, because of its design steps, provides appreciable relief in the area of the leaf spring elements connecting the pressure plate with the housing. Of course, the leaf spring arrangements 16 can also have a plurality of such leaf spring elements stacked one upon the other. Further, depending on the design construction, a sufficient relieving of the coupling areas in the push state can also result even when support of the leaf spring arrangements 16 is provided only in one of its end areas or near one of its coupling areas.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

I claim:

1. A thrust plate assembly for a friction clutch, said thrust plate assembly comprising
a pressure plate having a first mounting area,
a housing having an axis of rotation and a second mounting area,
at least one leaf spring arrangement which holds said pressure plate so as to be movable axially with respect to said housing, said leaf spring arrangement having a first coupling area secured to said first mounting area, a first longitudinal area adjoining said first coupling area, a second coupling area secured to said second mounting area, and a second longitudinal area adjoining said second coupling area, and
a leaf spring arrangement support arranged so that, when the first coupling area and the second coupling area approach one another in a circumferential direction with respect to said axis of rotation, at least one of said first longitudinal area and said second longitudinal area contacts the leaf spring arrangement support.

2. A thrust plate assembly as in claim 1 wherein neither the first longitudinal area nor the second longitudinal area contacts the leaf spring support arrangement when the leaf spring arrangement is essentially not loaded.

3. A thrust plate assembly as in claim 1 wherein the leaf spring arrangement support has at least one of a first support surface adjacent to the first mounting area and a second support surface adjacent to the second mounting area.

4. A thrust plate assembly as in claim 3 wherein at least one of the first and second mounting areas has a surface region adjoining a respective one of the first and second support surfaces, which surface region is coupled to a respective one of the first and second coupling areas of the leaf spring arrangement.

5. A thrust plate assembly as in claim 4 wherein at least one of the surface regions is essentially flat, and at least one of the first and second support surfaces is curved away from the leaf spring arrangement.

6. A thrust plate assembly as in claim 1 wherein at least one of the first and second coupling areas is inclined at an acute angle with respect to a plane which is orthogonal to the axis of rotation.

7. A thrust plate assembly as in claim 4 wherein at least one of the first and second coupling areas is inclined at an acute angle with respect to a plane which is orthogonal to the axis of rotation, and wherein the surface region of at least one of the first and second mounting areas is inclined at an acute angle with respect to said plane.

8. A thrust plate assembly as in claim 1 wherein said leaf spring arrangement further comprises a connection area connecting said first and second coupling areas, at least one of said first and second coupling areas, at least in an essentially unloaded state of said leaf spring arrangement, being inclined with respect to said connection area.

9. A thrust plate assembly as in claim 1 wherein at least one leaf spring arrangement comprises at least one leaf spring element.

10. A friction clutch comprising a thrust plate assembly, said thrust plate assembly comprising
a pressure plate having a first mounting area,
a housing having an axis of rotation and a second mounting area,
at least one leaf spring arrangement which holds said pressure plate so as to be movable axially with respect to said housing, said leaf spring arrangement having a first coupling area secured to said first mounting area, a first longitudinal area adjoining said first coupling area, a second coupling area secured to said second mounting area, and a second longitudinal area adjoining said second coupling area, and
a leaf spring arrangement support arranged so that, when the first coupling area and the second coupling area approach one another in a circumferential direction with respect to said axis of rotation, at least one of said first longitudinal area and said second longitudinal area contacts the leaf spring arrangement support.
